(19) United States
(12) Patent Application Publication
(10) Pub. No.: US 2009/0085994 A1
(43) Pub. Date: Apr. 2, 2009

(54) LIQUID DISCHARGING APPARATUS

(75) Inventor: Masayuki TAKATA, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 12/243,812

(22) Filed: Oct. 1, 2008

(30) Foreign Application Priority Data
Oct. 1, 2007 (JP) 2007-257994

(51) Int. Cl. B41J 2/17

(52) U.S. Cl. 347/94

(57) ABSTRACT

The image forming apparatus includes a liquid discharging head that discharges a liquid; and a damper chamber that is provided in a liquid supply flow channel, the damper chamber being an internal space that is formed by bonding a flexible member to a base member, wherein the flexible member has a bonding surface that is bonded to the base member, an opening that is formed in the bonding surface, and a swollen portion that is three-dimensionally swollen from the edge of the opening to form the damper chamber, the base member has a communicating port, through which the damper chamber and the liquid supply flow channel communicate with each other, in a state where the base member is bonded to the bonding surface of the flexible member and closes the opening, and the flexible member is disposed such that the swollen portion is swollen in a gravity direction.

### CROSS REFERENCE TO RELATED APPLICATION

The present application claims priority from Japanese Patent Application No. 2007-257994, which was filed on Oct. 1, 2007, the disclosure of which is herein incorporated by reference in its entirety.

### TECHNICAL FIELD

Apparatus consistent with the present invention relate to a liquid discharging apparatus such as an ink jet printer or the like.

### BACKGROUND

Japanese unexamined patent application publication No. 2005-271546 (hereinafter called JP2005-271546) describes a related art tube supply-type ink jet printer. For example, the related art tube supply-type ink jet printer temporarily stores in a buffer tank on a carriage ink supplied from an ink cartridge through a flexible ink supply tube, and appropriately supplies ink from the buffer tank to an ink jet head. Then, ink is discharged from nozzles of the ink jet head, such that an image is recorded on a sheet or the like.

In this ink jet printer, an acceleration caused by an inertial force is applied to ink in the ink supply tube due to acceleration and deceleration of the carriage. If doing so, pressure wave is propagated to ink in the ink jet head, which adversely affects a meniscus formed in the nozzles of the ink jet head. For this reason, a damper chamber sealed with a flexible film is provided in the buffer tank on the upstream side of the ink jet head, thereby absorbing dynamic pressure applied to ink.

### SUMMARY

The above described related art apparatus has a few disadvantages. For example, in recent years, with demands for compact ink jet printers, the carriage and mounting parts tend to be reduced in size, and accordingly, the damper chamber is also reduced in size. If the damper chamber is reduced in size, and the area of the flexible film is decreased, pressure change absorption performance is deteriorated.

Accordingly, it is an aspect of the present invention to achieve apparatus compactness and effectively improve damper performance.

According to an exemplary embodiment of the present invention, a liquid discharging apparatus comprises: a liquid discharging head that discharges a liquid onto a recording medium, the liquid, which is supplied from a liquid supply source, being supplied to the liquid discharging head through a liquid supply flow channel; and a damper chamber that is provided in the liquid supply flow channel to relieve pressure of the liquid in the liquid supply flow channel, the damper chamber being an internal space that is formed by bonding a flexible member to a base member, wherein the flexible member has a bonding surface that is bonded to the base member, an opening that is formed in the bonding surface, and a swollen portion that is three-dimensionally swollen from the edge of the opening to form the damper chamber, the base member has a communicating port, through which the damper chamber and the liquid supply flow channel communicate with each other, in a state where the base member is bonded to the bonding surface of the flexible member and closes the opening, and the flexible member is disposed such that the swollen portion is swollen in a gravity direction.

### BRIEF DESCRIPTION OF THE DRAWINGS

Illustrative aspects of the invention will be described in detail with reference to the following figures wherein:

FIG. 1 is a schematic perspective view showing parts of an ink jet printer according to an exemplary embodiment of the present invention;

FIG. 2 is a plan view of a head unit of the ink jet printer shown in FIG. 1;

FIG. 3 is a perspective view of the head unit in the ink jet printer shown in FIG. 1;

FIG. 4 is an exploded perspective view of the head unit in the ink jet printer shown in FIG. 1;

FIG. 5 is a perspective view of a base member and a flexible film shown of the head unit in FIG. 4 when viewed from the below;

FIG. 6 is an enlarged perspective view of parts of the base member shown in FIG. 5 when viewed from the below;

FIG. 7 is a perspective view of the flexible film shown in FIG. 5 when viewed from the above;

FIG. 8 is a sectional view taken along the line V-V of FIG. 2;

FIG. 9 is a sectional view taken along the line VI-VI of FIG. 2;

FIG. 10 is a perspective view showing one from among four ink flow channels in the head unit shown in FIG. 4;

FIG. 11 is a perspective view of a cooling liquid flow channel in the head unit shown in FIG. 4;

FIG. 12 is a schematic view showing a case where the head unit shown in FIG. 2 is turned at a right end; and

FIG. 13 is a schematic view showing a case where the head unit shown in FIG. 2 is turned at a left end.

### DETAILED DESCRIPTION OF EXEMPLARY EMBODIMENTS OF THE PRESENT INVENTION

An exemplary embodiment of the present invention will now be described with reference to the drawings. In the following description, a direction in which ink is discharged from an ink jet head is referred to as downward, and an opposite side thereof is referred to as upward.

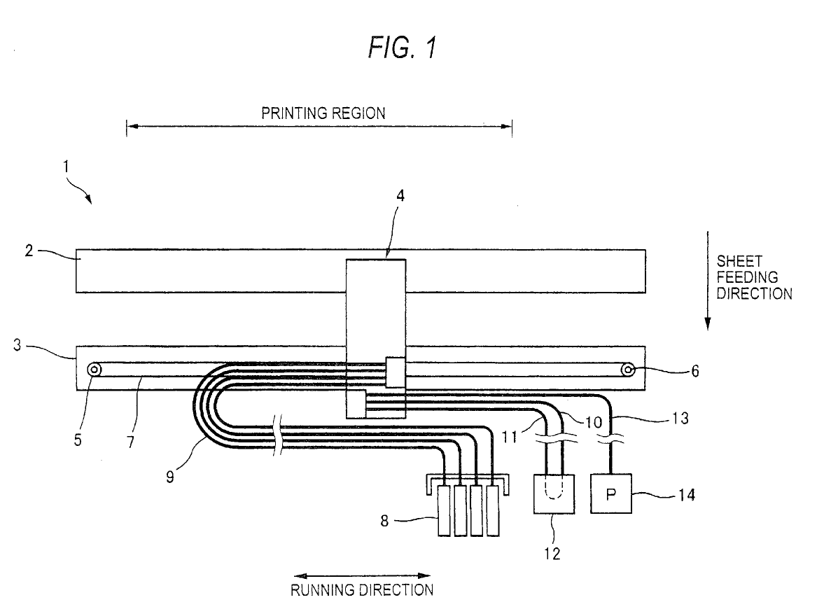

FIG. 1 is a schematic perspective view showing parts of an ink jet printer 1 according to an exemplary embodiment of the present invention. As shown in FIG. 1, the ink jet printer 1 (liquid discharging apparatus) is provided with a pair of guide rails 2 and 3 substantially arranged in parallel, and a head unit 4 is supported by the guide rails 2 and 3 so as to be slidable in a running direction. The head unit 4 is bonded with a timing belt 7 that is wound around a pair of pulleys 5 and 6, and the timing belt 7 is substantially arranged in parallel with an extension direction of the guide rail 3. A motor (not shown) which normally and reversely rotates is provided in one pulley 6. Normal and reverse rotation of the pulley 6 causes the timing belt 7 to reciprocate, and the head unit 4 is reciprocally moved in one direction along the guide rails 2 and 3.

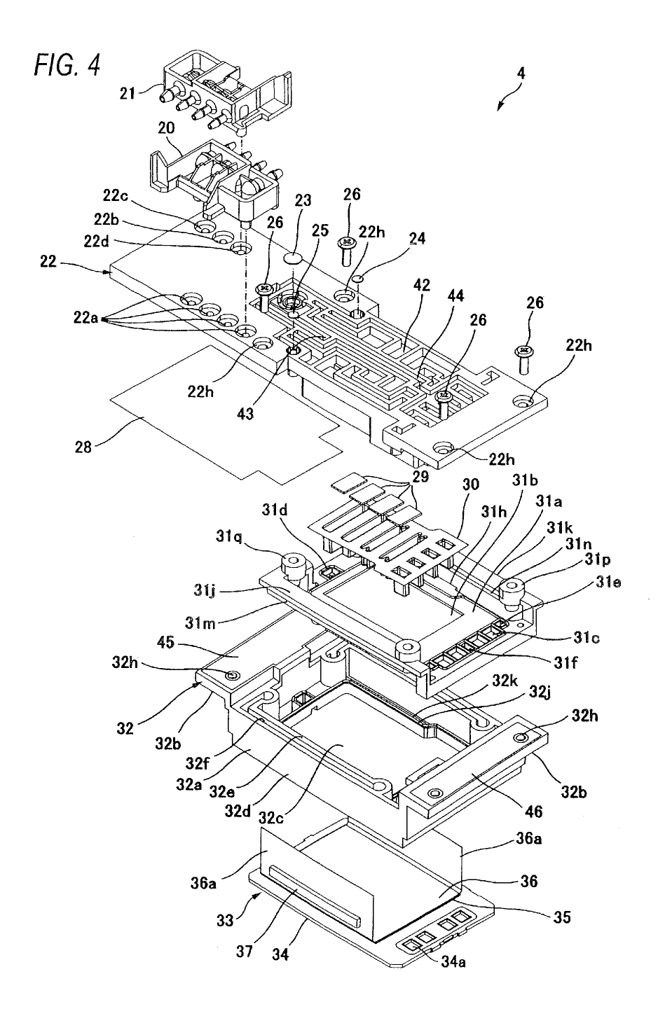

Four flexible ink supply tubes 9 (liquid supply tube) to supply ink of four colors (black, cyan, magenta, and yellow) from four ink cartridges 8 (liquid supply source) are connected to the head unit 4. An ink jet head 33 (described below with reference to FIG. 4) is mounted on the head unit 4, and ink (liquid) is discharged from the ink jet head 33 toward a recording medium (for example, recording sheet) which is conveyed in a direction (sheet feed direction) perpendicular to the running direction below the ink jet head 33.

A flexible outgoing tube 10 and a flexible returning tube 11 are connected to the head unit 4. The outgoing tube 10 forms a cooling liquid outgoing channel, and the returning tube 11 forms a cooling liquid returning channel. The outgoing tube 10 and the returning tube 11 are connected so as to circulate with each other by a radiator tank 12. An end of a flexible negative pressure suction tube 13 is connected to the head unit 4. The negative pressure suction tube 13 extracts air trapped in a flow channel of the head unit 4. The other end of the negative pressure suction tube 13 is connected to a negative pressure pump 14.

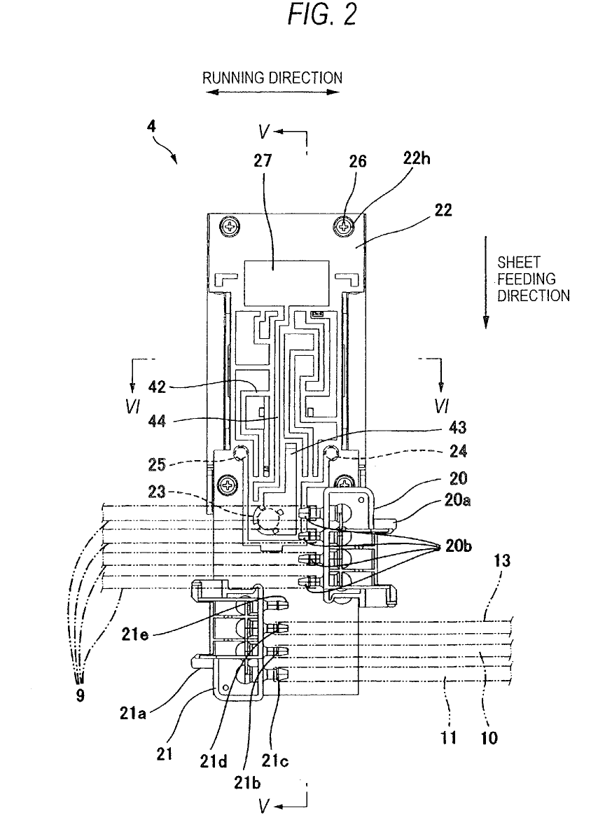

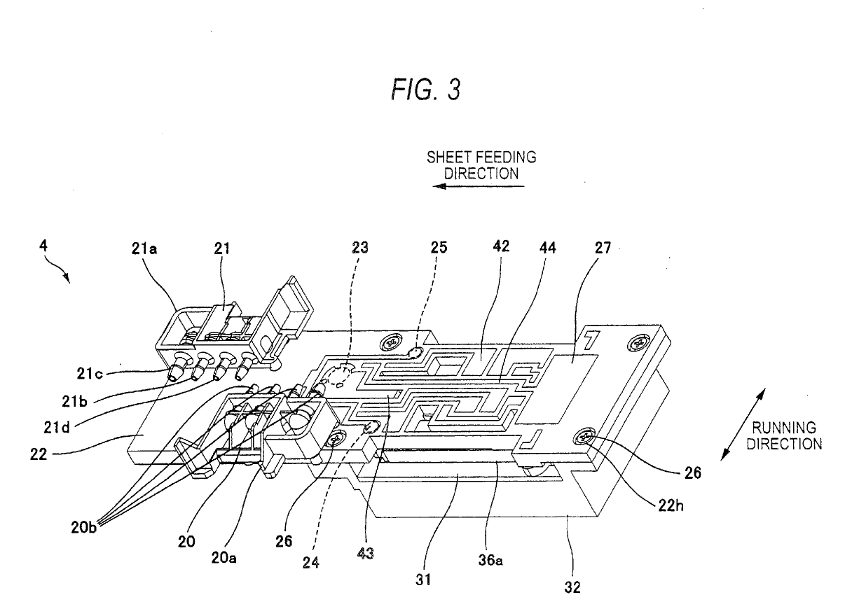

FIG. 2 is a plan view of the head unit 4 in the ink jet printer 1 shown in FIG. 1. FIG. 3 is a perspective view of the head unit 4 in the ink jet printer 1 shown in FIG. 1. FIG. 4 is an exploded perspective view of the head unit 4 in the ink jet printer 1 shown in FIG. 1. In FIG. 4, a film which is welded to an upper surface of a base member 22 is not shown. As shown in FIGS. 2 to 4, the head unit 4 includes joints 20 and 21, the base member 22, check valves 23 to 25, screws 26, air-liquid separation films 27 and 29, a flat film 28, a flexible film 30, an elastic seal member 31, a carriage 32, and the ink jet head 33.

The joint 20 for ink has a base portion 20a that is attached to the upper surface of the base member 22, and four ink joint tube portions 20b that are led from the base portion 20a toward one side (a left side in FIG. 2) in the running direction of the carriage 32. The ink supply tubes 9 are correspondingly connected to the ink joint tube portions 20b. The joint 20 is made of hard resin (for example, polypropylene), and the ink supply tubes 9 are made of soft resin (for example, nylon). The joint 20 has hardness larger than those of the ink supply tubes 9. Therefore, the environs of connection portions of the ink supply tubes 9 to the ink joint tube portions 20b are kept to be led to one side (the left side in FIG. 2) in the running direction of the carriage 32.

The joint 21 for cooling liquid and negative pressure suction has a base portion 21a that is attached to the upper surface of the base member 22, and four joint tube portions 21b, 21c, 21d, and 21e that are led from the base portion 21a toward the other side (a right side in FIG. 2) in the running direction of the carriage 32. Two from among the four joint tube portions 21b, 21c, 21d, and 21e are cooling liquid joint tube portions 21b and 21c for cooling liquid, one is a negative pressure joint tube portion 21d for negative pressure suction, and the other one is an unusable joint tube portion 21e (in terms of common utilization of parts, the joint 21 is the same as the joint 20 in structure, and thus an unusable joint tube portion 21e is provided).

The outgoing tube 10 is connected to the cooling liquid joint tube portion 21b, the returning tube 11 is connected to the cooling liquid joint tube portion 21c, and the negative pressure suction tube 13 is connected to the negative pressure joint tube portion 21d. The joint 21 is made of hard resin (for example, polypropylene), and the outgoing tube 10, the returning tube 11, and the negative pressure suction tube 13 are made of soft resin (for example, nylon). The joint 21 has hardness larger than the outgoing tube 10, the returning tube 11, and the negative pressure suction tube 13. Therefore, the environs of connection portions of the outgoing tube 10, the returning tube 11, and the negative pressure suction tube 13 to the cooling liquid joint tube portions 21b, 21c, and 21d are kept to be led to the other side (the right side in FIG. 2) in the running direction of the carriage 32.

The base member 22 substantially has a flat plate shape, and is provided with a plurality of grooves in the upper and lower surfaces. A plurality of flow channels are provided by thermally welding a film to the upper and lower surfaces so as to seal the grooves. Specifically, the base member 22 is provided with four ink inlet port 22a in the upper surface on a downstream side in the sheet feed direction and the other side in the running direction. The base member 22 is also provided with a cooling liquid inlet port 22b, a cooling liquid outlet port 22c, and a negative pressure suction port 22d in the upper surface on the downstream side of the sheet feed direction and the one side of the running direction. The base member 22 is also provided with a carriage-side ink flow channel 42 that communicates with the ink inlet ports 22a, a cooling liquid flow channel 43 that communicates with the cooling liquid inlet port 22b and the cooling liquid outlet port 22c, and an air exhaust flow channel 44 that communicates with the negative pressure suction port 22d.

Three check valves 23 to 25 are arranged in the cooling liquid flow channel 43. The check valves 23 to 25 permits the flow of the cooling liquid from the cooling liquid inlet port 22b toward the cooling liquid outlet port 22c, and checks the flow of the cooling liquid from the cooling liquid outlet port 22c toward the cooling liquid inlet port 22b. Specifically, at a place where the flow of the cooling liquid from the cooling liquid inlet port 22b toward the cooling liquid outlet port 22c is directed from the lower surface of the base member 22 toward the upper surface, a lower-side small diameter flow channel and a large diameter flow channel connected to an upper side of the small diameter flow channel are provided in the cooling liquid flow channel 43. And, waterproof films are arranged in the large diameter flow channel as the check valves 23 to 25. The check valves 23 to 25 have a diameter larger than that of the small diameter flow channel and smaller than that of the large diameter flow channel, and has a specific gravity larger than that of the cooling liquid to be then freely floated. Therefore, if the cooling liquid goes from the cooling liquid inlet port 22b toward the cooling liquid outlet port 22c, the check valves 23 to 25 are floated and communicate with the small diameter flow channel and the large diameter flow channel. If the cooling liquid goes from the cooling liquid outlet port 22c toward the cooling liquid inlet port 22b, the check valves 23 to 25 are sunken and close the small diameter flow channel. Through holes 22h into which the screws 26 are inserted are provided at required places of the base member 22.

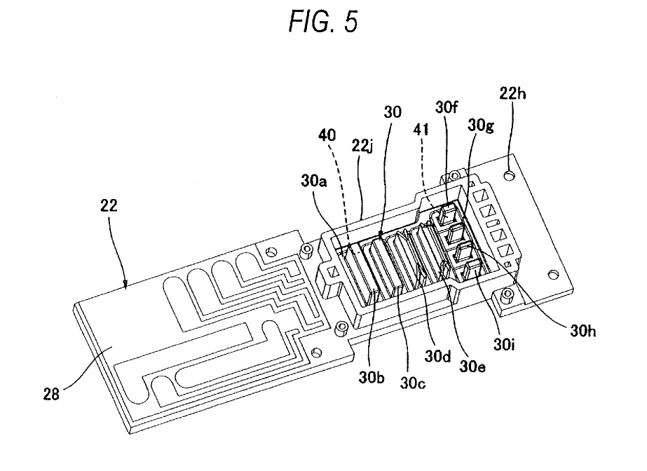

FIG. 5 is a perspective view when the base member 22 and the flexible film 30 in the head unit 4 shown in FIG. 4 are viewed from the below. As shown in FIG. 5, various flow channels are formed by sealing the grooves in the lower surface of the base member 22 with the flat film 28. A peripheral rib 22j is formed in the lower surface of the base member 22 to protrude downward. The flexible film 30 is thermally welded inside the peripheral rib 22j. The flexible film 30 is three-dimensionally hot formed by a matched molding method and is made of a thin film resin. Large ink damper chambers 40 and small ink damper chambers 41 as parts of the ink flow channels are formed between the lower surface of the base member 22 and the flexible film 30 to lesson a change in pressure of ink.

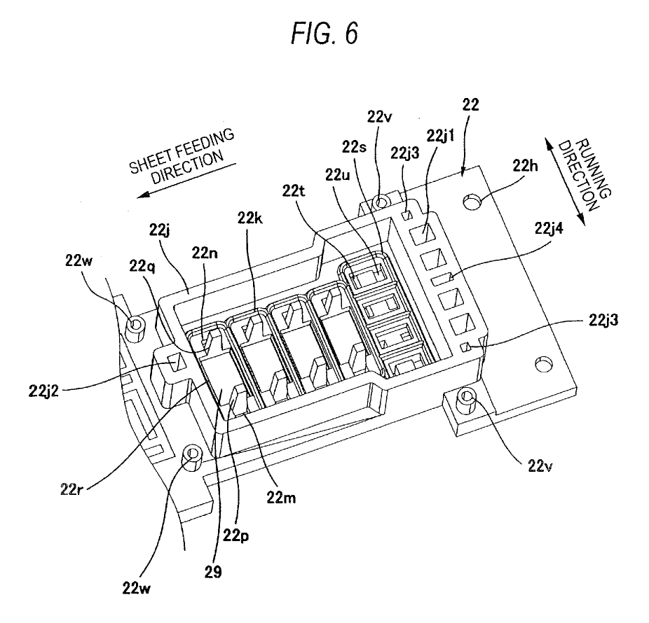

FIG. 6 is an enlarged perspective view of parts of the base member 22 shown in FIG. 5 when viewed from the below. As shown in FIG. 6, large peripheral uplifted portions 22k are provided inside the peripheral rib 22j in the lower surface of the base member 22, and the flexible film 30 is welded to the large peripheral uplifted portions 22k. The large peripheral uplifted portions 22k are arranged in a longitudinal direction (sheet feed direction) of the base member 22 so as to partition the large ink damper chamber 40 (see FIG. 5), which substantially has a rectangular shape in plan view, for each of four kinds of ink. Small peripheral uplifted portions 22s are provided adjacent to the large peripheral uplifted portions 22k. The small peripheral uplifted portions 22s are arranged in a widthwise direction (the running direction) of the base member 22 so as to partition the small ink damper chamber 41 (see FIG. 5), which substantially has a rectangular shape in plan view, for each of four kinds of ink.

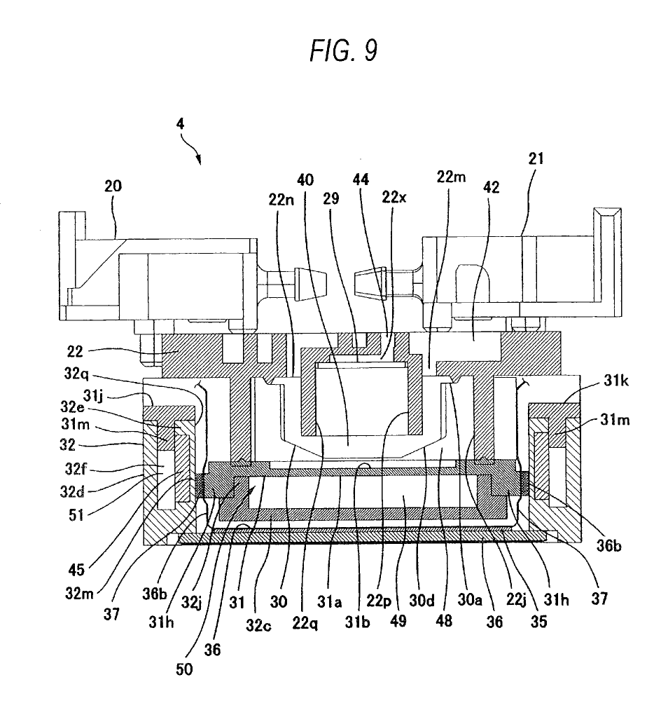

Inside each of the large peripheral uplifted portions 22k of the lower surface of the base member 22, an inlet port 22m and an outlet port 22n are formed on both sides in the long-side direction (running direction). The inlet port 22m and the outlet port 22n are holes that communicate with the carriage-side ink flow channel 42 in the upper surface of the base member 22. Protrusions 22p and 22q are provided between the inlet port 22m and the outlet port 22n to protrude toward the large ink damper chamber 40 in each of large swollen portions 30b to 30e (described below) of the flexible film 30. The protrusions 22p and 22q are provided so as not to be in contact with swollen portions 30b to 30e in a state where the large swollen portions 30b to 30e (described below) are at atmospheric pressure. A film attaching portion 22r to which air-liquid separation film 29 (semipermeable film) is attached is recessed between the protrusion 22p and the protrusion 22q to substantially have a rectangular shape in plan view. The air-liquid separation film 29 transmits gas but does not transmit a liquid. The air-liquid separation film 29 attached to the film attaching portion 22r is opposed to an opening 30x of each of the large swollen portions 30b to 30e (described below). A hole 22x (see FIG. 9) is provided in the film attaching portion 22r to communicate with the air exhaust flow channel 44 in the upper surface of the base member 22.

Inside each of the small peripheral uplifted portions 22s in the base member 22, an inlet port 22t and an outlet port 22u are formed on both sides of the long-side direction (sheet feed direction). The inlet port 22t and the outlet port 22u are holes that communicate the carriage-side ink flow channel 42 in the upper surface of the base member 22. In the peripheral rib 22j of the base member 22, four ink channels 22j1 are formed in an up-down direction to communicate with the outlet ports 22u on the upper surface side of the base member 22. The air-liquid separation film 27 is attached to the upper surface of the base member 22 to cover positions corresponding to the ink channels 22j1 and the outlet ports 22u. The air-liquid separation film 27 transmits gas but does not transmit a liquid.

On a downstream side in the sheet feed direction of the peripheral rib 22j of the base member 22, a cooling liquid channel 22j2 is formed in which the cooling liquid from the cooling liquid flow channel 43 flows downward. On a front side in the sheet feed direction of the peripheral rib 22j of the base member 22, a pair of cooling liquid channels 22j3 are formed on both sides in the running direction, in which the cooling liquid from a cooling liquid damper chamber 49 flows upward.

Near the cooling liquid channels 22j3 outside the peripheral rib 22j of the base member 22, a pair of cooling liquid channel cylindrical portions 22v are formed in which the cooling liquid flows downward. On the downstream side in the sheet feed direction outside the peripheral rib 22j of the base member 22, a pair of cooling liquid channel cylindrical portions 22w are formed in which the cooling liquid from an IC chip cooling channel 51. In the peripheral rib 22j of the base member 22, a cooling liquid channel 22j4 through which the cooling liquid damper chamber 49 (described below) communicates with the air-liquid separation film 27 is formed in the up-down direction between the inside two ink channels 22j1.

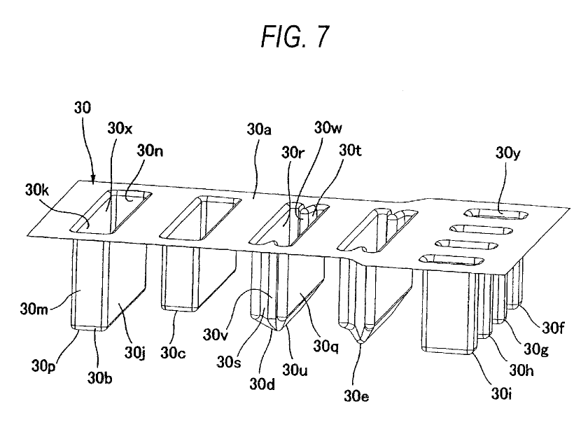

FIG. 7 is a perspective view of the flexible film 30 shown in FIG. 5 when viewed from the above. As shown in FIG. 7, the flexible film 30 has a bonding surface 30a, openings 30x and 30y, and large swollen portions 30b to 30e and small swollen portions 30f to 30i. The bonding surface 30a is bonded to the large peripheral uplifted portions 22k and the small peripheral uplifted portions 22s (see FIG. 6) of the base member 22. The openings 30x and 30y are formed in the bonding surface 30a and have a rectangular shape to be slightly smaller than the large peripheral uplifted portions 22k and the small peripheral uplifted portions 22s (see FIG. 6). The large swollen portions 30b to 30e and the small swollen portions 30f to 30i (recording liquid flexible walls) are three-dimensionally swollen from the edges of the opening 30x and 30y in a gravity direction away from the base member 22 (see FIG. 5). Therefore, by bonding the bonding surface 30a of the flexible film 30 to the base member 22 to close the openings 30x and 30y, the inner spaces of the four large swollen portions 30b to 30e form the large ink damper chambers 40 as parts of four kinds of ink flow channels. Further, the inner spaces of the four small swollen portions 30f to 30i form the small ink damper chambers 41 as parts of four kinds of ink flow channels. That is, as for one kind of ink, the large ink damper chamber 40 is disposed on the upstream side and the small ink damper chamber 41 is disposed on the downstream side. That is, a plurality of ink damper chambers 40 and 41 are disposed in one carriage-side ink flow channel 42.

The large swollen portions 30b to 30e individually have a pair of main surfaces 30j, 30k, 30q, and 30r that protrude from the edge of the long side of the opening 30x in the gravity direction and are opposed to each other, a pair of sub surfaces 30m, 30n, 30s, and 30t that protrude from the edge of the short side of the opening 30x in the gravity direction and are opposed to each other, and sub surfaces 30p and 30u that connect the main surfaces 30j, 30k, 30q, and 30r and the sub surfaces 30m, 30n, 30s, and 30t. That is, by bending the main surfaces 30j, 30k, 30q, and 30r of a large area to cause a large change in volume of the spaces in the large swollen portions 30b to 30e, when viewed from the above in plan view, even though the areas of the large swollen portions 30b to 30e are small, a large pressure change absorption effect can be obtained.

The large swollen portion 30b and the large swollen portion 30c substantially have the same shape but different lengths in the gravity direction. In the sub surfaces 30s and 30t of the large swollen portion 30d and the large swollen portion 30e, dent portions 30v and 30w are provided, the sections of which perpendicular to the main surfaces 30q and 30r have a dent shape. The sub surfaces 30u of the large swollen portion 30d and the large swollen portion 30e are crest portions whose sections perpendicular to the main surfaces 30q and 30r are crest shapes. With a cornice effect of the dent- or crest-shaped sub surfaces 30s, 30t, and 30u, the main surfaces 30q and 30r can move in the normal direction. Therefore, even though the areas of the large swollen portions 30d and 30e in plan view are small, a larger pressure change absorption effect can be obtained. The small swollen portions 30f to 30i substantially have the same as the large swollen portions 30b and 30c but different in size, and thus detailed descriptions thereof will be omitted. Moreover, the dent portions or the crest portions may be provided in the sub surfaces of all of the large swollen portions 30b to 30e, or may not be provided.

Returning to FIG. 4, the elastic seal member 31 is made of an elastic material, such as rubber, and has a flat plate portion 31a substantially having a rectangular shape in plan view. In the central portion of an upper surface of the flat plate portion 31a, a concave portion 31b is formed to correspond to the large swollen portions 30b to 30e and the small swollen portions 30f to 30i of the flexible film 30. The concave portion 31b has a rectangular shape in plan view and is thinned. In the end surfaces on both sides of the flat plate portion 31a in the running direction, press portions 31h are individually provided to protrude toward IC chips 37 (described below).

On the upstream side of the flat plate portion 31a in the sheet feed direction (longitudinal direction), four ink holes 31c are formed to communicate liquid-tight with the four ink channels 22j1 (see FIG. 6) of the base member 22. On the downstream side of the flat plate portion 31a in the sheet feed direction, a cooling liquid hole 31d is formed to communicate liquid-tight with the cooling liquid channel 22j2 (see FIG. 6) of the base member 22. On both sides of the ink hole 31c of the flat plate portion 31a in the running direction, a pair of cooling holes 31e are formed to communicate light-tight with the pair of cooling liquid channels 22j3 (see FIG. 6) of the base member 22. A cooling hole 31f is formed between the inside two ink holes 31c from among the four ink holes 31c of the flat plate portion 31a to communicate light-tight with the cooling liquid channel 22j4 (see FIG. 6) of the base member 22.

Above both sides of the flat plate portion 31a in the running direction, a pair of rod portions 31j and 31k which are connected to the flat plate portion 31a as a single body extend along the longitudinal direction of the flat plate portion 31a. In the lower surfaces of the rod portions 31j and 31k, strip protrusions 31m and 31n are formed. The strip protrusions 31m and 31n are pressed into and seal grooves 31f (described below) of the carriage 32, in which the cooling liquid flows, from the above. On the upstream sides of the rod portions 31j and 31k in the sheet feed direction, a pair of cooling liquid channel cylindrical portions 31p are formed to communicate liquid-tight with the pair of cooling liquid channel cylindrical portions 22v (see FIG. 6) of the base member 22, respectively. On the downstream sides of the rod portions 31j and 31k in the sheet feed direction, a pair of cooling liquid channel cylindrical portions 31q are formed to communicate liquid-tight with the pair of cooling liquid channel cylindrical portions 22w (see FIG. 6) of the base member 22, respectively.

The carriage 32 is made of resin, and has a concave portion 32a, and rail guide portions 32b that protrude in a flange shape from upper ends on both sides of the concave portion 32a in the sheet feed direction (longitudinal direction) and are guided to the guide rails 2 and 3 (see FIG. 1). The rail guide portions 32b are provided with screw holes 32h to which the screws 26 are fastened. The concave portion 32a is provided with an ink hole 32g, which communicates liquid-tight with the ink holes 31c of the elastic seal member 31, on the upstream side of a bottom wall portion 32c thereof in the sheet feed direction (longitudinal direction). Both sides of the concave portion 32a in the running direction have a double walled structure having an outer wall portion 32d and an inner wall portion 32e. A groove 32f is formed between the outer wall portion 32d and the inner wall portion 32e to form the IC chip cooling channel 51. Heat sinks 45 and 46 made of a metal, such as aluminum, are embedded in the inner wall portion 32e and the rail guide portions 32b by insert molding, respectively. At the bottom wall portion 32c inside the inner wall portion 32e, a seal mounting portion 32j protrudes upward at a position corresponding to the peripheral rib 22j of the base member 22. A slit 32k is provided at the bottom wall portion 32c between the seal mounting portion 32j and the inner wall portion 32e, and extended portions 36a and 36b of a flexible flat wire member 36 are inserted into the slit 32k from downward to upward.

The ink jet head 33 is attached to the lower side of the bottom wall portion 32c of the carriage 32. The ink jet head 33 has a flow channel unit 34 that has a plurality of ink chambers for guiding ink from the four ink inlet ports 34a to a plurality of nozzles (not shown), and a piezoelectric actuator 35 that is laminated on the upper surface of the flow channel unit 34 and selectively gives ejection pressure to ink in the flow channel unit 34 so as to be directed toward the nozzles. The ink inlet ports 34a of the flow channel unit 34 are covered with a filter 38. The ink inlet ports 34a communicate liquid-tight with the ink hole 32g of the carriage 32.

The flexible flat wire member 36 is bonded to the upper surface of the actuator 35. The flexible flat wire member 36 has a pair of extended portions 36a and 36b that extend from the upper surface of the actuator 35 toward both sides of the running direction. Actuator driving IC chips 37 are provided on the lower surfaces of the pair of extended portions 36a and 36b (on the outer surfaces when the pair of extended portions 36a and 36b turn upward).

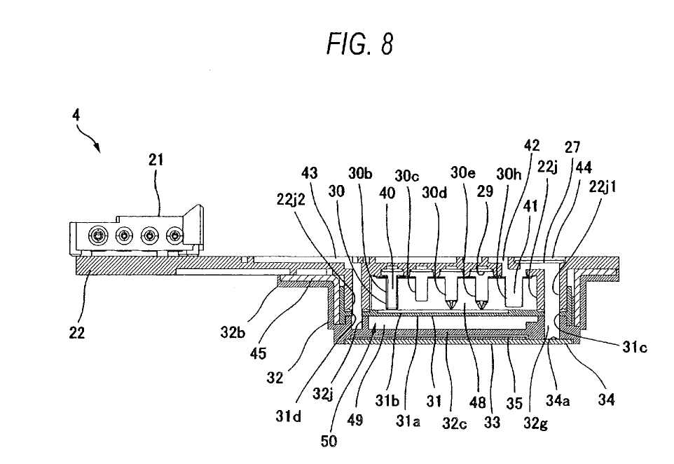

FIG. 8 is a sectional view taken along the line V-V of FIG. 2. FIG. 9 is a sectional view taken along the line VI-VI of FIG. 2. As shown in FIGS. 8 and 9, the flat plate portion 31a of the elastic seal member 31 is sandwiched between the peripheral rib 22j of the base member 22 and the seal mounting portion 32j of the carriage 32. The cooling liquid damper chamber 49 is formed in a space defined by the lower surface of the elastic seal member 31, the upper surface of the bottom wall portion 32c of the carriage 32, and an inner peripheral surface of the seal mounting portion 32j of the carriage 32. The cooling liquid damper chamber 49 forms a part of the cooling liquid flow channel 43, and is provided at a position corresponding to the actuator 35 of the ink jet head 33. The cooling liquid damper chamber 49 and the actuator 35 are disposed to be close each other with the bottom wall portion 32c interposed therebetween. That is, the cooling liquid damper chamber 49 also functions as an actuator cooling flow channel for cooling the actuator 35. An air layer 48 is formed in a closed space defined by the upper surface of the flat plate portion 31a of the elastic seal member 31, the outer surface of the flexible film 30, and an inner peripheral surface of the peripheral rib 22j of the base member 22.

The ink damper chambers 40 and 41 and the cooling liquid damper chamber 49 are separated from each other by the swollen portions 30h to 30i of the flexible film 30, the flat plate portion 31a of the elastic seal member 31, and the air layer 48. That is, the swollen portions 30b to 30i, the flat plate portion 31a, and the air layer 48 form a pressure transmission unit 50 that enables the ink damper chambers 40 and 41 and the cooling liquid damper chamber 49 to transmit pressure to each other.

As shown in FIG. 9, the protrusions 22p and 22q protrude in the large ink damper chamber 40 inside the large swollen portion 30d of the flexible film 30 so as not to be in contact with the large swollen portion 30d. Ink flowing from the inlet port 22m into the large ink damper chamber 40 goes round the protrusion 22p and flows in the central portion of the large ink damper chamber 40. Air bubbles of ink in the central portion of the large ink damper chamber 40 are raised by a buoyant force and guided to the air exhaust flow channel 44 through the air-liquid separation film 29. Then, ink in the central portion of the large ink damper chamber 40 goes round the protrusion 22q and flows in the outlet port 22n.

The strip protrusions 31m and 31n in the rod portions 31j of the elastic seal member 31 are pressed into the groove 32f which is formed between the outer wall portion 32d and the inner wall portion 32e of the carriage 32, thereby forming the IC chip cooling channel 51. The IC chip cooling channel 51 communicates with the cooling liquid flow channel 43 and the cooling liquid damper chamber 49. The heat sink 45 is formed at the inner wall portion 32e so as to be exposed to the cooling liquid flow channel 51 by insert molding and also functions as an inner wall portion. The extended portions 36a and 36b of the flexible flat wire member 36 pass through upward between the inner wall portion 32e of the carriage 32 and the flat plate portion 31a of the elastic seal member 31. The IC chip 37 is pressed against the inner wall portion 32e by the press portion 31h of the elastic seal member 31. That is, the IC chip 37 comes into contact with an outer surface 32q of a thin covering portion 32m that is made of resin and covers the heat sink 45 of the inner wall portion 32e of the carriage 32.

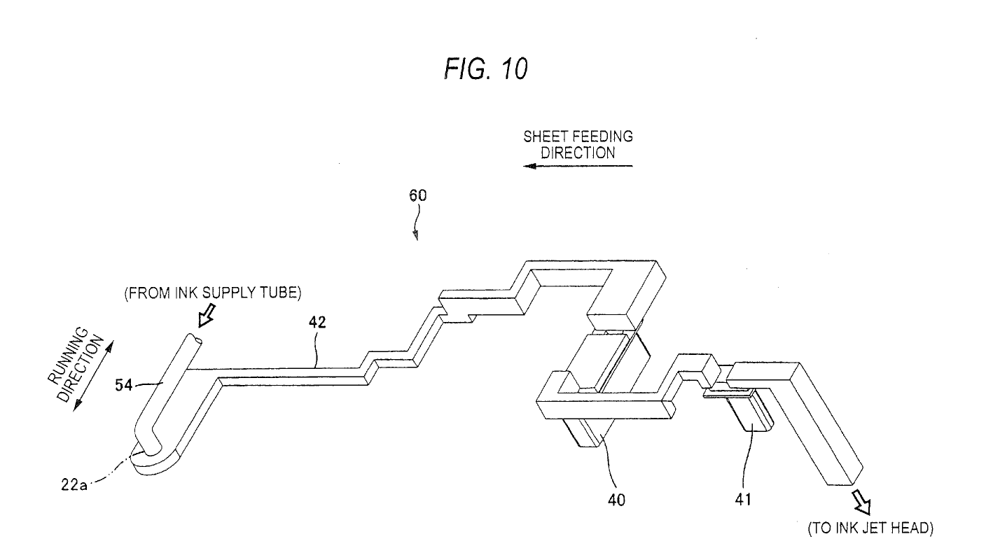

FIG. 10 is a perspective view showing one from among the four carriage-side ink flow channels 42 in the head unit 4 shown in FIG. 4. As shown in FIGS. 2 and 10, the carriage-side ink flow channel 42 has a lead portion 54 that is led from the head unit 4 on one side of the running direction. The lead portion 54 is formed by an inner flow channel of the ink joint tube portions 20b of the joint 20 and an inner flow channel near the connection portions of the ink supply tubes 9 to the ink joint tube portions 20b. Moreover, an ink flow channel 60 (liquid flow channel) from the ink cartridge 8 to the ink jet head 33 is formed by a flow channel in the ink supply tubes 9 and the carriage-side ink flow channel 42.

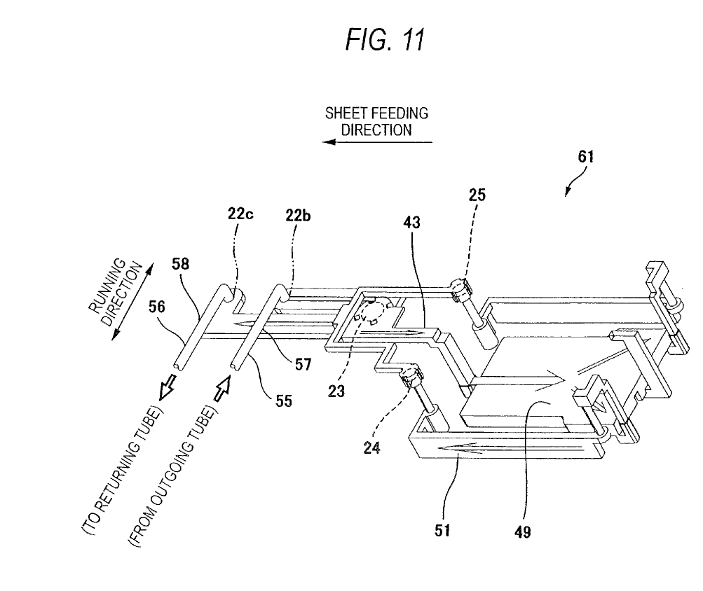

FIG. 11 is a perspective view of the cooling liquid flow channel 43 in the head unit 4 shown in FIG. 4. As shown in FIGS. 2, 4, and 11, the cooling liquid flow channel 43 communicates with a cooling liquid outgoing channel 55 connected to the cooling liquid inlet port 22b and a cooling liquid returning channel 56 connected to the cooling liquid outlet port 22c. The cooling liquid outgoing channel 55 is formed by an inner flow channel of the cooling liquid joint tube portion 21b of the joint 21, and an inner flow channel of the outgoing tube 10. The cooling liquid returning channel 56 is formed by an inner flow channel of the cooling liquid joint tube portion 21c of the joint 21 and an inner flow channel of the returning tube 11.

By determining the inner diameter of the cooling liquid returning channel 56 to be larger than the inner diameter of the cooling liquid outgoing channel 55, the cooling liquid returning channel 56 has flow channel resistance smaller than flow channel resistance of the cooling liquid outgoing channel 55. The inner diameters of the outgoing tube 10 and the returning tube 11 are larger than the inner diameter of each of the ink supply tubes 9, and the outgoing tube 10 and the returning tube 11 have hardness lower than hardness of the ink supply tubes 9.

The cooling liquid outgoing channel 55 and the cooling liquid returning channel 56 individually have lead portions 57 and 58 that are led from the head unit 4 toward the other side of the running direction. The lead portions 57 and 58 are individually formed by inner flow channels of the cooling liquid joint tube portions 21b and 21c of the joint 21, and inner flow channels near connection portions of the outgoing tube 10 and the returning tube 11 to the cooling liquid joint tube portions 21b and 21c. The check valve 23 is provided on the upstream side of the cooling liquid damper chamber 49 and the downstream side of the lead portion 57, and the check valves 24 and 25 are provided on the downstream side of the cooling liquid damper chamber 49 and the upstream side of the lead portion 58. A cooling liquid circulation flow channel 61 is formed by a flow channel in the radiator tank 12, a flow channel in the outgoing tube 10, a flow channel in the joint 21, the cooling liquid flow channel 43, and a flow channel in the returning tube 11.

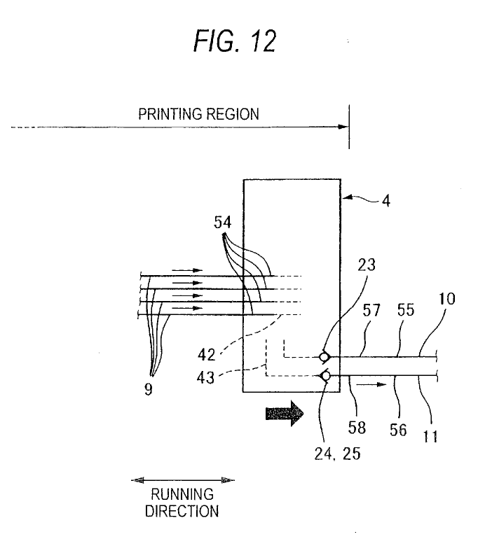

FIG. 12 is a schematic view showing a case where the head unit 4 shown in FIG. 2 is turned at a right end (the other end). As shown in FIG. 12, when the head unit 4 is turned at the right end in the running direction, the head unit 4 is decelerated at a predetermined deceleration and is stopped at the right end, and then moves rightward while being accelerated at a predetermined acceleration. Therefore, positive pressure is applied to the carriage-side ink flow channel 42 due to an inertial force of ink in the lead portion 54 of the carriage-side ink flow channel 42. Meanwhile, negative pressure is applied to the cooling liquid flow channel 43 due to an inertial force of the cooling liquid in the lead portion 58 of the cooling liquid returning channel 56. That is, the cooling liquid from the cooling liquid flow channel 43 does not flow back to the cooling liquid outgoing channel 55 due to the check valve 23, but it passes through the check valves 24 and 25 and flows out to the cooling liquid returning channel 56. Therefore, negative pressure is generated in the cooling liquid flow channel 43. Then, if an inertial force in a right direction of the running direction applied to the cooling liquid in the lead portion 57 of the cooling liquid outgoing channel 55 is eliminated, the cooling liquid in the cooling liquid outgoing channel 55 passes through the check valve 23 and flows into the cooling liquid flow channel 43 due to the negative pressure of the cooling liquid flow channel 43.

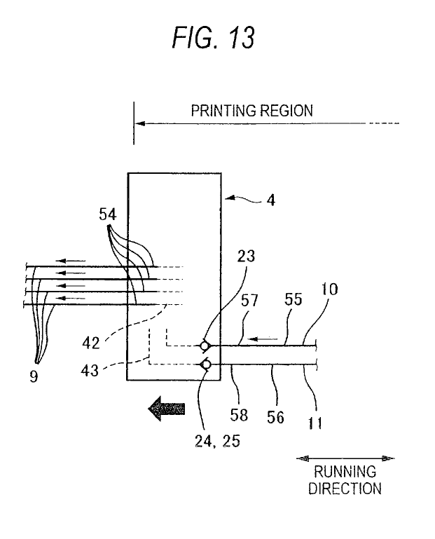

FIG. 13 is a schematic view showing a case where the head unit 4 shown in FIG. 2 is turned at a left end. As shown in FIG. 13, when the head unit 4 is turned at the right end in the running direction, negative pressure is applied to the carriage-side ink flow channel 42 due to the inertial force of ink in the lead portion 54 of the carriage-side ink flow channel 42. Meanwhile, positive pressure is applied to the cooling liquid flow channel 43 due to the inertial force of the cooling liquid in the lead portion 57 of the cooling liquid outgoing channel 55. That is, the cooling liquid from the cooling liquid outgoing channel 55 passes through the check valve 23 and flows into the cooling liquid flow channel 43, while the cooling liquid from the cooling liquid flow channel 43 does not flow out to the cooling liquid returning channel 56 due to the check valves 24 and 25. Therefore, positive pressure in the cooling liquid flow channel 43 is increased. Then, if an inertial force in a left direction of the running direction applied to the cooling liquid of the lead portion 58 of the cooling liquid returning channel 56 is eliminated, the cooling liquid in the cooling liquid flow channel 43 passes through the check valves 24 and 25 and flows out to the cooling liquid returning channel 56 due to the positive pressure in the cooling liquid flow channel. That is, the cooling liquid is circulated by using the inertial force applied to the cooling force due to the reciprocation of the head unit 4, without using an electric-powered pump.

According to the above configuration, the flexible film 30 is three-dimensionally formed by the swollen portions 30b to 30i. Therefore, the possible amount of deformation is increased, as compared with a known planar damper wall. Therefore, even if the damper area in plan view is small, a large pressure change absorption effect is obtained. As a result, compactness of the ink jet printer 1 can be achieved and the change in pressure can be sufficiently absorbed. In addition, the swollen portions 30b to 30i are swollen in the gravity direction, and ink is accumulated in the damper chambers 40 and 41 in the swollen portion 30b to 30i due to a self-weight. Therefore, it is possible to prevent the swollen portions 30b to 30i from shriveling and being flattened.

The flexible film 30 is hot formed by using a matched molding method and the flexible film 30 is formed to have a uniform thickness all over. Therefore, it is possible to suppress a variation in the pressure change absorption effect due to a difference in film rigidity between products or a local difference in rigidity in the same film. In addition, since the flexible film 30 is bonded to the base member 22 by thermal welding, sealability of the damper chambers 40 and 41 between the base member 22 and the flexible film 30 is improved. Furthermore, since the flexible film 30 is a single-layered film, even if the swollen portions 30b to 30i are formed deep, the film thickness can be maintained uniformly.

The swollen portions 30b to 30i have the main surfaces 30j, 30k, 30q, and 30r, and the sub surfaces 30m, 30n, 30s, 30t, 30p, and 30u. And, the main surfaces 30j, 30k, 30q, and 30r having a large area are flexed and accordingly a large change in volume occurs in the concave spaces 40 and 41. Therefore, even if the area of each of the swollen portions 30b to 30i in plan view is small, a large pressure change absorption effect can be obtained. In addition, with the cornice effect of the dent portions 30v and 30w and the crest portion 30u in the a sub surfaces 30s, 30t, and 30u of the swollen portions 30b to 30i, the main surfaces 30q and 30r are largely movable in the normal direction. Therefore, even if the area of the swollen portion 30d is small, a larger pressure change absorption effect can be obtained.

The base member 22 has the air-liquid separation films 27 and 29 at the upward positions opposed to the openings 30x and 30y of the swollen portions 30b to 30i. Therefore, even if air bubbles flows into the damper chambers 40 and 41, the air bubbles are separated from ink and trapped by the air-liquid separation films 27 and 29. As a result, it is possible to prevent air bubbles from reaching the ink jet head 33.

A plurality of damper chambers 40 and 41 are disposed in one flow channel of the ink supply flow channel 60. Therefore, a change in pressure of ink of different colors is sequentially absorbed by the plurality of damper chambers 40 and 41 from the upstream side to the downstream side over time. As a result, the change in pressure can be effectively and reliably absorbed.

The base member 22 has the protrusions 22p and 22q to protrude damper chamber 40 of each of the large swollen portions 30b to 30e. Therefore, even if the flexible large swollen portions 30b to 30e are unexpectedly to be collapsed, the swollen portions 30b to 30e are supported by the protrusions 22p and 22q. Therefore, it is possible to prevent the flexible member 30 from being bonded to the base member 22 with the swollen portions 30b to 30e crushed when manufacturing. In addition, the protrusions 22p and 22q are disposed so as not to be in contact with the large swollen portions 30b to 30e in a state where the large swollen portions 30b to 30e are at atmospheric pressure. Therefore, the protrusions 22p and 22q are usually not in contact with the large swollen portions 30b to 30e, and as a result, it is possible to prevent the flexible member 30 from being damaged when manufacturing.

The base member 22 has the inlet port 22m and the outlet port 22n at the positions opposed to the large swollen portions 30b to 30e, and the protrusions 22p and 22q are disposed between the inlet port 22m and the outlet port 22n. With this configuration, the protrusions 22p and 22q block the flow of ink from the inlet port 22m to the outlet port 22n. Therefore, a change in pressure of ink can be sufficiently absorbed by the damper chamber 40 over time. In addition, the inlet ports 22m and 22t are disposed in one end portions of the openings 30x and 30y of the swollen portions 30b to 30i in the long-side direction. Therefore, as for high pressure immediately after ink is introduced from the inlet ports 22m and 22t to the damper chambers 40 and 41, a change in pressure can be rapidly absorbed by using the end-portion regions of the swollen portion 30b to 30i having a large reaction force against volume expansion. Furthermore, the outlet ports 22n and 22u are provided in the other end portions opposite to the inlet ports 22m and 22t in the long-side direction, and the distance between inlet ports 22m and 22t and the outlet ports 22n and 22u becomes long. As a result, ink can flow out from the outlet ports 22n and 22u after the change in pressure is sufficiently absorbed.

In this exemplary embodiment, the ink supply flow channel 60 is an ink supply flow channel that constantly communicates the ink cartridge 8 and the ink jet head 33 with each other, but this is not intended to limit the invention. For example, the ink supply flow channel 60 may be an ink supply flow channel 60 that, as occasion demands, communicates the ink cartridge 8 and the ink jet head 33 with each other. In this case, preferably, communication and non-communication are made between the damper chambers 40 and 41 and the ink cartridge 8, and the damper chambers 40 and 41 and the ink jet head 33 constantly communicate with each other. Although in the exemplary embodiment the present invention is applied to the ink jet printer, the present invention may be applied to a liquid discharging apparatus that ejects a liquid other than ink, for example, an apparatus that ejects a coloring liquid to manufacture color filters for a liquid crystal display, or an apparatus that ejects a conductive liquid to form electric wires. Further, although in the exemplary embodiment the present invention is applied to the ink jet printer that has the ink jet head 4 as shown in FIG. 1, the present invention may be applied to a liquid discharging apparatus that has a line type inkjet head.

As described above, the liquid discharging apparatus according to the present invention has an excellent effect in achieving apparatus compactness and sufficiently absorbing a change in pressure. Advantageously, the present invention can be widely applied to an ink jet printer that is capable of exerting the significance of this effect.

According to an aspect of the present invention, a liquid discharging apparatus includes: a liquid discharging head that ejects liquid droplets onto a recording medium, a liquid from a liquid supply source being supplied to the liquid discharging head through a liquid supply flow channel. A damper chamber is provided in the liquid supply flow channel to relieve pressure of a liquid in the flow channel. The damper chamber is an internal space that is formed by bonding a flexible member to a base member, and the flexible member has a bonding surface that is bonded to the base member, openings that are formed in the bonding surface, and swollen portions that are three-dimensionally swollen from the edges of the openings to form the damper chamber. The base member has a communicating port, through which the damper chamber and the liquid supply flow channel communicate with each other in a state where the base member is bonded to the bonding surface of the flexible member and closes the openings. The flexible member is disposed such that the swollen portions are swollen in a gravity direction.

With this configuration, since the flexible member is three-dimensionally formed to have the swollen portions, the possible amount of deformation is increased, as compared with a known planar damper wall. Therefore, even if the damper area in plan view is small, a large pressure change absorption effect is obtained. As a result, apparatus compactness can be achieved and the change in pressure can be sufficiently absorbed. In addition, the swollen portions are swollen toward the gravity direction, and the liquid is accumulated in the concave space of each of the swollen portion due to a self-weight. Therefore, it is possible to prevent the swollen portions from shriveling and being flattened.

The liquid supply flow channel according to the invention is not limited to a liquid supply flow channel that constantly communicates the liquid supply source and the liquid discharging head with each other, but it may include a liquid supply flow channel that, as occasion demands, communicates the liquid supply source and the liquid discharging head with each other.

The flexible member may be made of a thin film-shaped flexible film, and the flexible film may be hot formed by using a matched molding method and bonded to the base member by thermal welding.

With this configuration, the flexible film is formed to have a uniform thickness all over. Therefore, it is possible to suppress a variation in the pressure change absorption effect due to a difference in film rigidity between products or a local difference in rigidity in the same film. In addition, since the flexible film is bonded by thermal welding, sealability of the damper chamber between the base member and the flexible film is improved.

The flexible film may be single-layered.

With this configuration, the flexible film is a single-layered film. Therefore, even if the swollen portions are formed deep, the film thickness can be maintained uniformly.

Each of the swollen portions may have a pair of main surfaces that protrude from the edge of a corresponding opening opposed to the base member in a direction away from the base member and are opposed to each other, and a sub surface that connects the pair of main surfaces with each other and has a smaller area than those of the main surfaces.

With this configuration, the main surfaces having a large area are flexed and accordingly a large change in volume occurs in the concave portions of the swollen portions. Therefore, even if the area of each of the swollen portions in plan view is small, a large pressure change absorption effect can be obtained.

The sub surface may have a crest portion or a dent portion whose section perpendicular to the main surfaces has a crest shape or a dent shape.

With this configuration, with a cornice effect of the crest portion or the dent portion in the sub surface, the main surfaces are largely movable in the normal direction. Therefore, even if the area of the swollen portion is small, a larger pressure change absorption effect can be obtained.

The base member may have air-liquid separation films that are provided at positions opposed to the openings of the swollen portions.

With this configuration, when air bubbles flows into the damper chamber from the upstream side, the air bubbles are separated from the liquid and trapped by the air-liquid separation films opposed to the openings of the swollen portions. Therefore, it is possible to prevent air bubbles from reaching the liquid discharging head.

A plurality of damper chambers may be disposed in one flow channel of the liquid supply flow channel.

With this configuration, as for the liquid flowing in one liquid supply flow channel, a change in pressure is sequentially absorbed by the plurality of damper chambers from the upstream side to the downstream side. Therefore, the change in pressure can be effectively and reliably absorbed.

The base member may have protrusions that are formed to protrude toward the damper chamber in the swollen portions.

With this configuration, even if the flexible swollen portions are unexpectedly to be collapsed, the swollen portions are supported by the protrusions. Therefore, it is possible to prevent the flexible member from being bonded to the base member with the swollen portions crushed when manufacturing.

The protrusions may be disposed so as not to be in contact with the swollen portions in a state where the swollen portions are at atmospheric pressure.

With this configuration, the protrusions are usually not in contact with the swollen portions. Therefore, it is possible to prevent the flexible member from being damaged when manufacturing.

The base member may have an inlet port and an outlet port as the communicating port that are formed at positions opposed to the swollen portion, and the protrusions may be disposed between the inlet port and the outlet port.

With this configuration, the protrusions block the flow of the liquid from the inlet port to the outlet port. Therefore, the change in pressure of the liquid can be sufficiently absorbed by the damper chamber in the swollen portion over time.

Each of the openings may be shaped to have a long side and a short side in plan view, the inlet port may be disposed at a position corresponding to one end portion in a long-side direction of the opening, and the outlet port may be disposed at a position corresponding to the other end portion in the long-side direction of the opening.

With this configuration, the inlet port is disposed in one end portion of the opening of each of the swollen portions. Therefore, as for high pressure immediately after the liquid is introduced from the inlet port to the damper chamber of the swollen portion, a change in pressure can be rapidly absorbed by using the end-portion region of the swollen portion having a large reaction force against volume expansion. In addition, the outlet port is provided in the other end portion opposite to the inlet port in the long-side direction, and thus a distance between the inlet port and the outlet port becomes long. As a result, the liquid can flow out from the outlet port after the change in pressure is sufficiently absorbed.

The liquid supply flow channel may have a flow channel that is formed by a liquid supply tube connected to the liquid supply source, and a flow channel that is formed by the base member connected to the liquid supply tube.

With this configuration, even if a change in pressure is transmitted from the liquid supply source or the liquid supply tube, the change in pressure can be sufficiently absorbed by the damper chamber.

The liquid discharging head and the damper chamber may be disposed on a carriage reciprocating with respect to the recording medium.

With this configuration, even if a change in pressure occurs in the liquid supply flow channel due to an inertial force caused by the reciprocation of the carriage, the change in pressure can be sufficiently absorbed by the damper chamber. In addition, it is possible to prevent the change in pressure from being transmitted to the liquid discharging head.

As will be apparent from the above description, according to the invention, the flexible member is three-dimensionally formed to have the swollen portions. Therefore, apparatus compactness can be achieved and a change in pressure can be sufficiently absorbed. In addition, the swollen portions are swollen in the gravity direction, and the liquid is accumulated in the concave space of each of the swollen portions from shriveling and being flattened.

What is claimed is:

1. A liquid discharging apparatus comprising:
a liquid discharging head that discharges a liquid onto a recording medium, the liquid, which is supplied from a liquid supply source, being supplied to the liquid discharging head through a liquid supply flow channel; and
a damper chamber that is provided in the liquid supply flow channel to relieve pressure of the liquid in the liquid supply flow channel, the damper chamber being an internal space that is formed by bonding a flexible member to a base member,
wherein
the flexible member has a bonding surface that is bonded to the base member, an opening that is formed in the bonding surface, and a swollen portion that is three-dimensionally swollen from the edge of the opening to form the damper chamber,
the base member has a communicating port, through which the damper chamber and the liquid supply flow channel communicate with each other, in a state where the base member is bonded to the bonding surface of the flexible member and closes the opening, and
the flexible member is disposed such that the swollen portion is swollen in a gravity direction.

2. The liquid discharging apparatus according to claim 1,
wherein the flexible member is made of a thin film-shaped flexible film, and
the flexible film is hot formed by using a matched molding method and bonded to the base member by thermal welding.

3. The liquid discharging apparatus according to claim 2,
wherein the flexible film is single-layered.

4. The liquid discharging apparatus according to claim 1,
wherein the swollen portion have a pair of main surfaces that protrude from the edge the opening opposed to the base member in a direction away from the base member and are opposed to each other, and a sub surface that connects the pair of main surfaces with each other and has a smaller area than that of the main surface.

5. The liquid discharging apparatus according to claim 4,
wherein the sub surface has at least one of a crest portion whose section perpendicular to the main surface has a crest shape and a dent portion whose section perpendicular to the main surface has a dent shape.

6. The liquid discharging apparatus according to claim 1,
wherein the base member has an air-liquid separation film that is provided at a position opposed to the opening of the swollen portion.

7. The liquid discharging apparatus according to claim 1,
wherein a plurality of the damper chambers are disposed in one flow channel of the liquid supply flow channel.

8. The liquid discharging apparatus according to claim 1,
wherein the base member has a protrusion that is formed to protrude toward the damper chamber in the swollen portion.

9. The liquid discharging apparatus according to claim 8,
wherein the protrusion is disposed so as not to be in contact with the swollen portion in a state where the swollen portion is at atmospheric pressure.

10. The liquid discharging apparatus according to claim 8,
wherein the base member has an inlet port and an outlet port as the communicating port which are formed at positions opposed to the swollen portion, and the protrusion is disposed between the inlet port and the outlet port.

11. The liquid discharging apparatus according to claim 10,
wherein the opening is shaped to have a long side and a short side in plan view,
the inlet port is disposed at a position corresponding to a first end portion in a long-side direction of the opening, and
the outlet port is disposed at a position corresponding to a second end portion opposite to the first end portion in the long-side direction of the opening.

12. The liquid discharging apparatus according to claim 1,
wherein the liquid supply flow channel has a flow channel that is formed by a liquid supply tube connected to the liquid supply source, and a flow channel that is formed by the base member connected to the liquid supply tube.

13. The liquid discharging apparatus according to claim 1,
wherein the liquid discharging head and the damper chamber are disposed on a carriage that reciprocates with respect to the recording medium.
